(19) United States
(12) Patent Application Publication
(10) Pub. No.: US 2005/0160962 A1
(43) Pub. Date: Jul. 28, 2005

(54) Ramp for pontoon boat

(76) Inventor: William C. Wright, Flowery Branch, GA (US)

Correspondence Address: Harry I. Leon, 924 Bowen St., NW, Atlanta, GA, 30318, US

(21) Appl. No.: 11/085,301

(22) Filed: Mar. 21, 2005

Related U.S. Application Data
(63) Continuation-in-part of application No. 10/431,021, filed on May 7, 2003, now Pat. No. 6,868,799.

(51) Int. Cl. B60P 3/10; B63C 13/00; B63B 21/64; B63B 17/00

(52) U.S. Cl. 114/362

(57) ABSTRACT

A ramp for a pontoon boat, or the like, in which a boat user can come and go from the pontoon boat, or the like, without having to get wet. The ramp is equipped with a cylinderal float not only keeps the ramp and user afloat which and is also ideally suited for docking an a typical beach since the float acts like a roller that allows the ramp to move up on the shore. A further object is to provide a platform projecting from the boat to assist swimmers in entering or leaving the boat. A further object of this invention is to provide a means for a handicap person to have access to the boat. The ramp comprises of a support structure attached in most cases to the underside of the boat, a platform that is slidablly fitted with into the support structure. The support structure has an elongated bearing that allows the platform to easily slide into the support structure. A cylindrical float is rotatably attached to the free end of the platform which is capable of holding both ramp together with at least one person utilizing the ramp. The ramp in its retracted position is stored on the underside of the pontoon boat. When needed it can be easily manually extended or retracted by the use of a rudder rotatably attached to the inboard end of the ramp. The rudder, when turned approximately 90 degrees to the center-line of the ramp the water force on the rudder when the boat is moving will move the ramp.

### RELATED U.S. APPLICATION DATA

This a continuation-in-part application of pending application having Ser. No. 10/431,021 having filing date May 7, 2003.

### BACKGROUND OF THE INVENTION

The previous application disclosed a floatable ramp for a pontoon boat. The previous ramp was extended and retracted by two methods one the ramp was manually and the second used an electric motor. An alternate method using a rudder for extension and retraction of the ramp is disclosed herein.

### SUMMARY OF INVENTION

The primary object of the present invention is to provide a floatable ramp for a pontoon boat, or the like, across which a boat user can come and go, without having to get wet.

A further object of this invention is to provide such a ramp which can be used to assist swimmers as they enter or leave the boat.

A further object of this invention is to provide a ramp which, while it is projecting from the boat, can be moved easily up and onto a typical beach, thereby facilitating docking.

A still further object of this invention is to facilitate access to the boat by a handicapped person.

A still further object is to provide a novel method of moving the ramp without the need for manual or electrical power.

An improved ramp assembly comprises a ramp platform (hereinafter referred to as “ramp”) and a support structure which is attachable, in most instances, to the underside of a pontoon boat. The ramp is slideably connected to the support structure by the use of a pair of shafts in a grooved bearing structure. As the ramp is being extended outwardly from or, alternately, retracted into the support structure, the bearing blocks ride on elongated bearing surface tracks mounted within the support structure.

A cylindrical float, rotatably mounted on the free end of the ramp, has sufficient buoyancy to support it, as well as a user, when the ramp is fully extended. The cylindrical float not only keeps the ramp afloat but also acts like a wheel during docking, enabling one to move the ramp, in its extended position, up and onto the shore at most beaches.

The ramp is extended by releasing of a lock and turning the activation rudder so the face of the ramp rudder to approximately 90 degrees to the direction or motion of the boat and move the boat in reverse direction to the extending ramp.

To store the ramp on the underside of the pontoon boat, again turn the activation rudder so the face of the rudder is approximately 90 degrees to the longitudinal center line of the boat and at the same time move the boat in the forward direction.

The ramp lock can be released by pulling a rope or cable that is attached to control arm from any convenient location in the boat.

### BRIEF DESCRIPTION OF THE DRAWINGS

FIGS. 1 and 2 are right side perspective views of the improved ramp assembly with the ramp in its extended and retracted positions, respectively, relative to its support structure;

FIG. 3 is an exploded view of the ramp assembly according to FIG. 1, illustrating components of the ramp assembly ready for installation on a typical pontoon boat;

FIG. 4 is a closeup view, on an enlarged scale, of a fragmentary portion of the ramp assembly according to FIG. 1, showing the float and a pair of mounting brackets on the free end of the ramp;

FIG. 5 is a transverse cross-section, on an enlarged scale, of fragmentary portions of the support structure and of the ramp, including a shaft mounted thereon which terminates in a bearing block, the bearing block being slideably received within a bearing surface track mounted within the support structure;

FIG. 6 is a perspective view of the underside of a pontoon boat on which the ramp assembly according FIG. 1 has been installed, the ramp being shown in a fully extended position, the pontoon boat forming no part of the invention;

FIGS. 7A and 7B are perspective views of the topside of a pontoon boat on which the ramp assembly according FIG. 1 has been installed, the ramp being shown in extended and retracted positions in FIGS. 7A and 7B, respectively;

FIGS. 8A and 8B shows a close up view of the ramp activation rudder in the active and inactive position, respectively the shroud, connector and control arm have been removed for clarity in FIG. 8A;

FIGS. 9A and 9B shows a close up view of a ramp activation rudder control mechanism in the unlocked and locked position, respectively; and

FIGS. 10A and 10B shows a close up view of the ramps locking control mechanism in the unlocked and locked position respectively.

### DETAILED DESCRIPTION OF THE PREFERRED EMBODIMENT

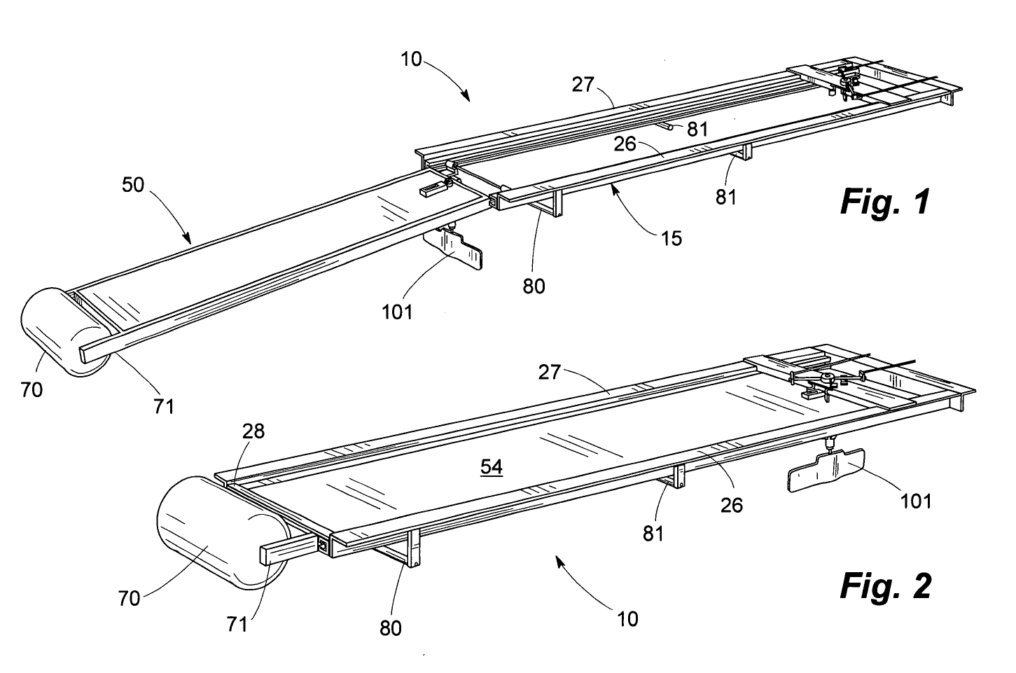

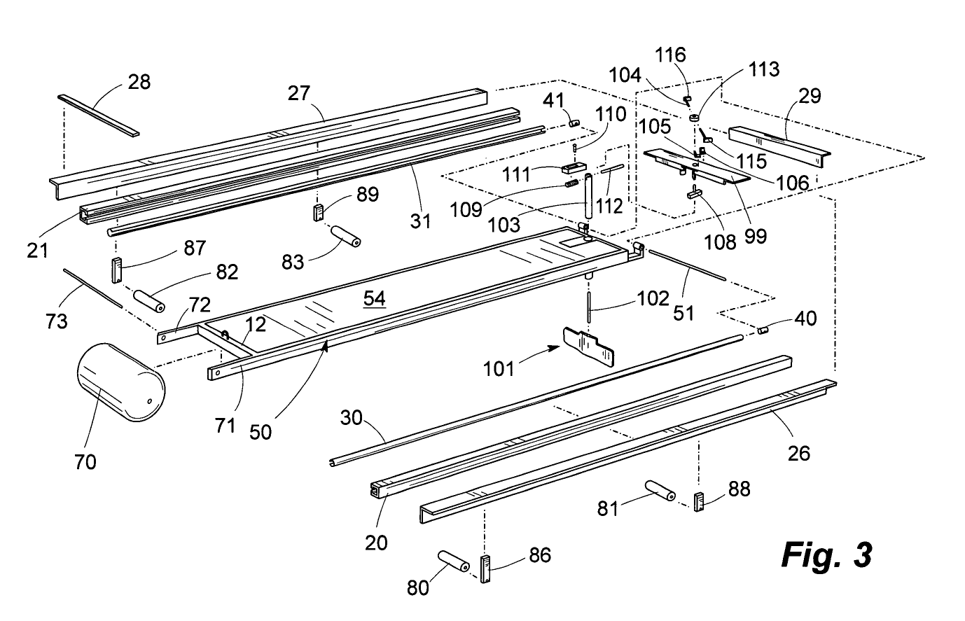

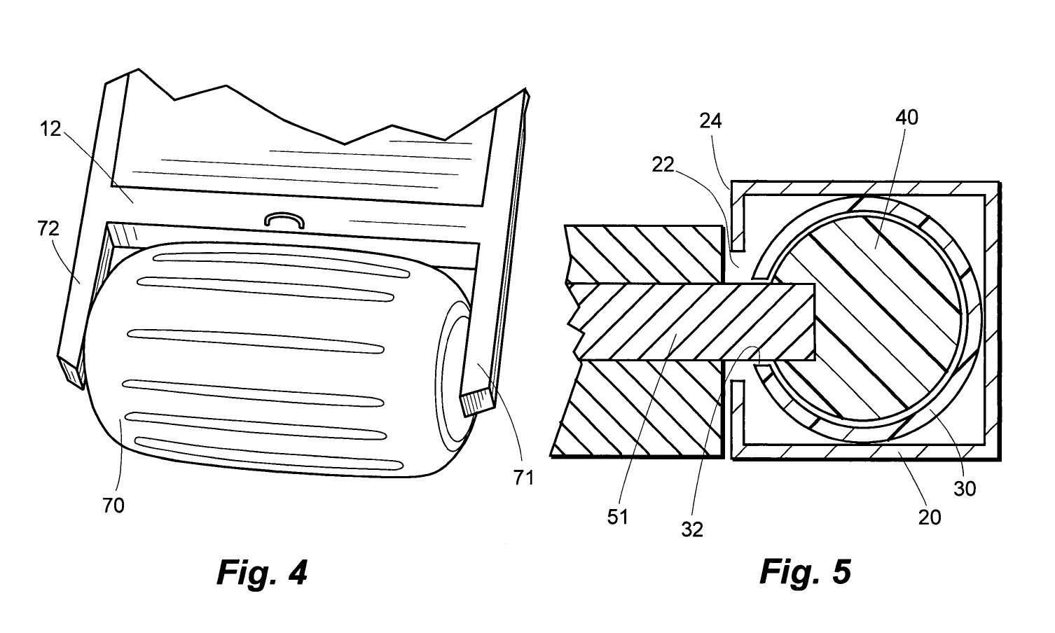

In the drawings, an improved ramp assembly is indicated generally by the reference numeral 10. The ramp assembly 10 comprises a support structure 15 and a platform 50 (FIGS. 1-3). Distal ends of the platform 50 are supported by a shaft 51 and a float 70, which is rotatably mounted on an axle 73. The axle 73 is held in place by a pair of brackets 71, 72 (FIG. 3). Bearing blocks 40, 41, which are mounted perpendicularly to the shaft 51, suspend it and the platform 50, which is pivotally connected thereto, horizontally between rails 20, 21 (FIGS. 3 and 5). The rails 20, 21, together with angle members 26, 27 and cross members 28, 29, comprise the support structure 15 (FIGS. 1 and 3).

Preferably fabricated from square channel tubing, the rail 20 includes a wall 24 with an elongated slot 22 (FIG. 5). In the support structure 15, the slot 22 is aligned generally parallel with a similar elongated slot in the rail 21 (FIG. 3).

Mounted within each rail 20, 21, an elongated bearing surface track 30 defines a slit 32 which preferably extends the length of the track (FIGS. 3 and 5). As illustrated in FIG. 5, the slit 32 faces inwardly towards the contiguous slot 22 in the rail 20. Likewise, both the slit 32 and the elongated slot in the rail 21 are contiguous and face inwardly (FIG. 3).

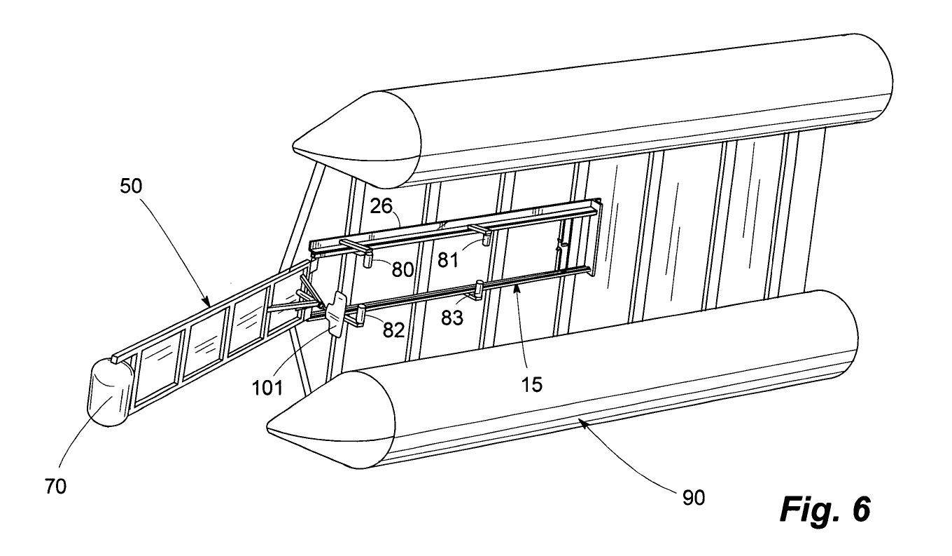

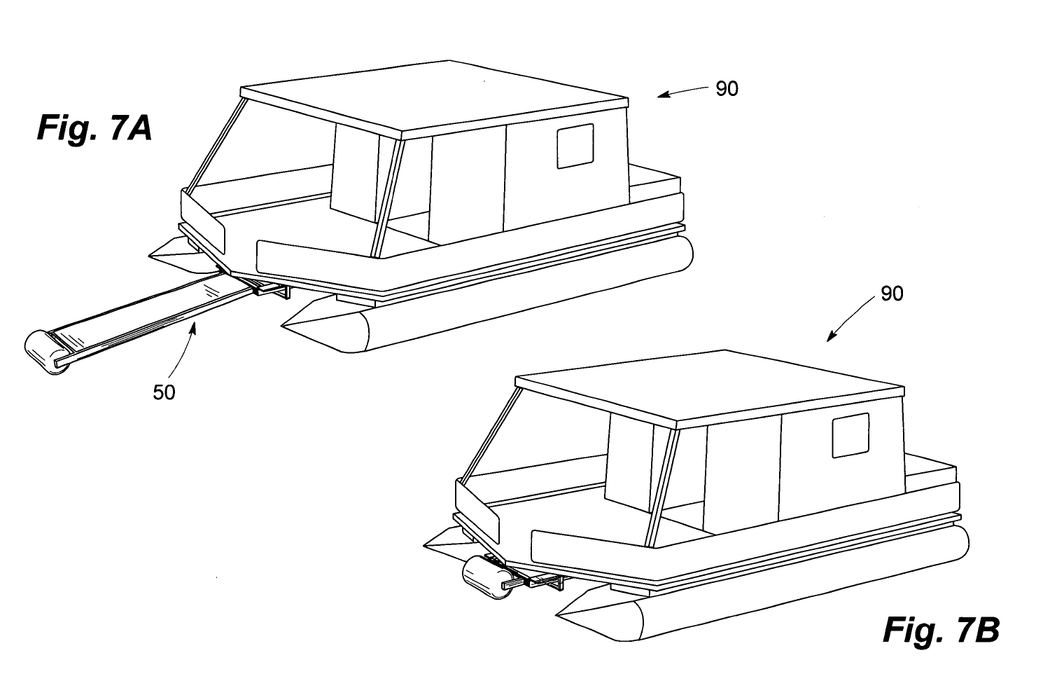

In use, the bearing blocks 40, 41 slideably ride within the bearing surface tracks 30, 31, respectively (FIGS. 3 and 5). As one moves the platform 50 into its extended position, the bearing blocks 40, 41 slide rearward—relative to the front end of pontoon boat 90—within the elongated bearing surface tracks 30, 31 (FIGS. 3, 6 and 7A). Alternately, when the platform 50 is being retracted, the blocks 40, 41 slide forward.

In the platform 50, elongated side members, of which the brackets 71, 72 are forward extensions, and cross members 12, 13 comprise a generally rectangular frame to which sheet metal or the like is attached (FIGS. 1-3). The sheet metal is preferably covered with an exterior carpet 54 for extra safety.

Fitted between the brackets 71, 72, the cylindrical float 70 preferably has sufficient buoyancy to keep the aft end of the platform 50 above the water surface even when a user is standing on the platform. Easily rotatable about the axle 73, the float 70 also acts as a wheel for helping a user dock the platform 50 on a beach.

Means for stabilizing the platform 50 as it is being extended or retracted includes a two pair of guides on each side of the platform 80, 81 and 82, 83 which are rotatably connected to vertical supports 87, 89; 86, 88, respectively (FIG. 3). The guides 80, 82 also support the free end of the platform 50 when the pontoon boat 90 is in dry dock. Vertical supports 86, 88; 87, 89 themselves are rigidly attached to angle members 26, 27 from which they extend downwardly (FIG. 3).

The platform 50 can be extended or retracted by the ramp rudder activation system 100 comprised of rudder 101 supported on the lower end of shaft 102, the shaft rotates in bearing 103 and has a rudder control means. When the rudder 101 is turned 90 degrees to the longitudinal axis of the ramp by using by the control handle 104, the force of the water on the rudder 101 while the boat is moving backward allows for the extension of the ramp 50. To retract the rudder the boat direction is reversed.

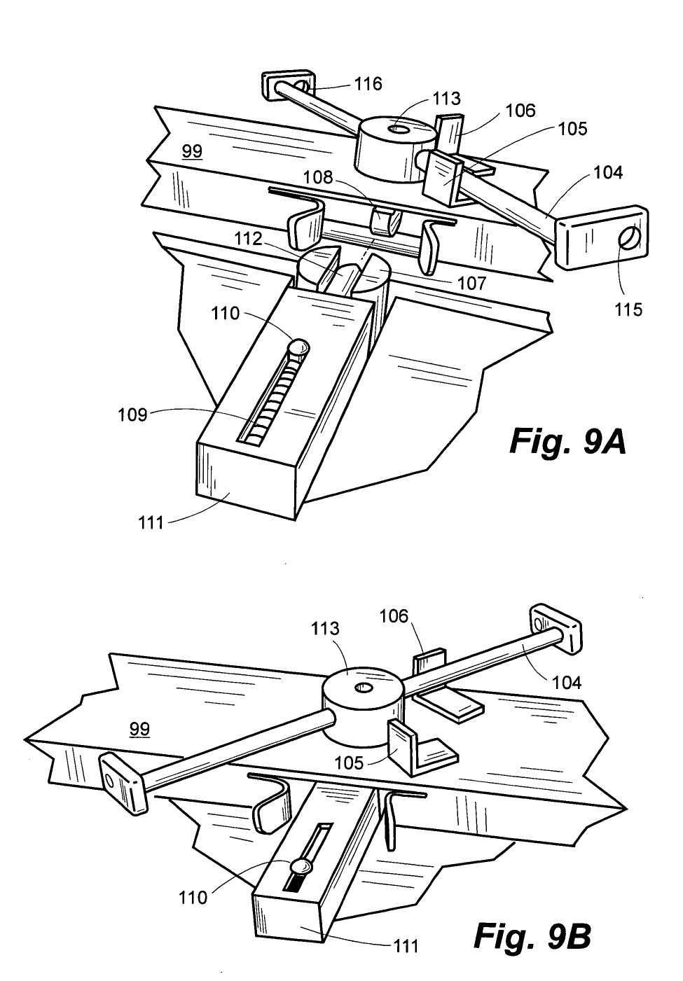

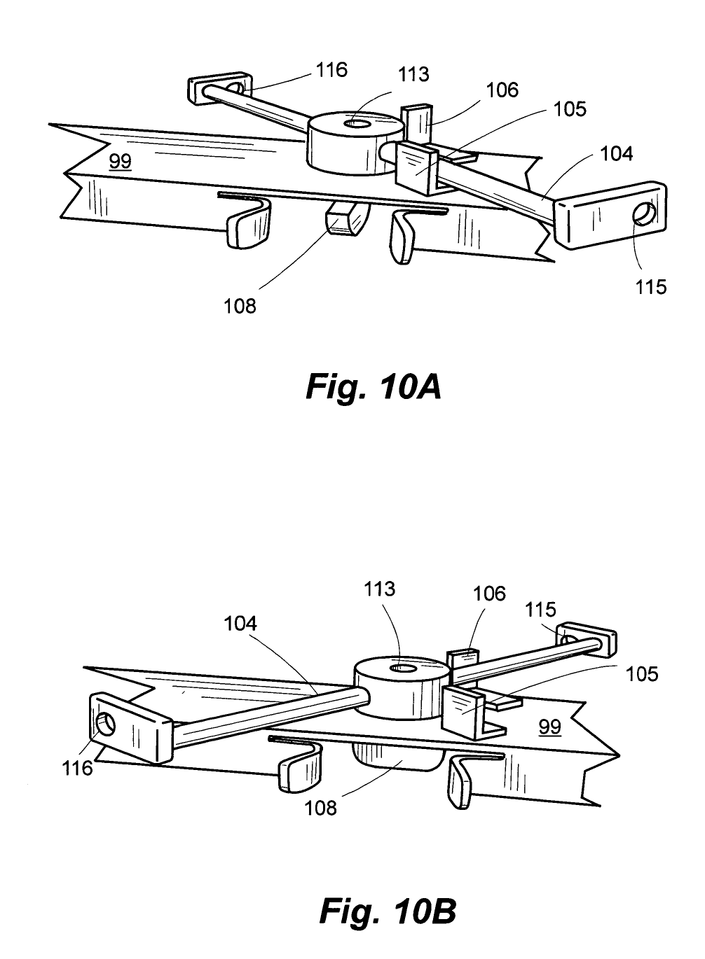

The details of the locking and unlocking is as follows. While the ramp While the ramp is in the stored position, the control handle 104 is temporarily connected to the upper end shaft 102 by the connector 113 which contains a key 108 (located below the shroud 99) that slidablely fits in groove 107 at the top end of shaft 102. To extend the ramp the control handle 104 is rotated 90 degrees which is when the handle 104 reaches the stop 105, the rudder 101 is moved 90 degrees. (See FIG. 9A). When the rudder 101 is rotated approximately 90 degrees and simultaneously the boat 90 is driven backward the force of the rudder in the water starts to extend the ramp. To lock the rudder in the rotated position while the ramp is extending, a pin 112 is pushed into groove 107 and held in place by a compression spring 109 in its housing 111. To keep pin 112 from being ejected a knob 110 rides in a groove in the housing 111.

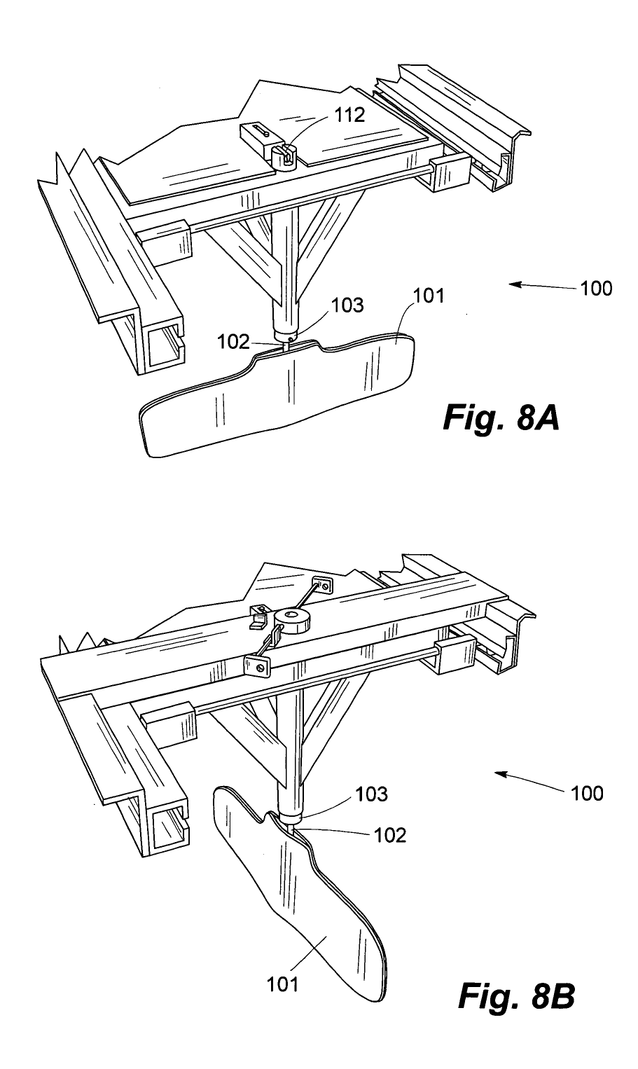

To store and lock the retracting ramp again referring to FIGS. 9A and 9B. As the ramp 50 is approaches its stored position the key 108 comes into contact with the pin 112 and the pin 112 is pushed out of the groove 107. In this position the handle 104 can then be turned from stop 105 to stop 106 which both moves the rudder from 90 degrees to alignment with the longitudinal axis of the ramp and locks the ramp in stored position as shown on FIG. 8B.

The control arm 104 and the knob 110 are shown where they be manually activated near the rudder, however, a system of ropes, cables, solenoids or the like can easily be devised to attach to holes 115, 116 on the ends of control arm 104 so that this ramp control could be activated from any place on the boat.

In the prototype, the rails 20, 21 were fabricated from a pair of 2 inch square aluminum channels, each of which measures 8 feet long and has a wall thickness of 1/4 inch. The elongated bearing tracks 30, 31 were made from Schedule 40, 1 1/2 inch O.D. PVC pipe. Generally cylindrical in shape and sized so that they can be slideably fitted within the elongated bearing tracks 30, 31, bearing blocks 40, 41 measure, by way of example, 1 inch in diameter and 2 inches in length. In this configuration, friction between the bearing blocks 40, 41 and the bearing surface tracks 30, 31 is sufficiently low that retracting the platform 50 requires one to exert a force of only about 10 pounds.

The platform 50 in the same prototype includes a frame fabricated from 1 inch square channel aluminum tubing and an 1/8 inch thick aluminum sheet. The latter is attached to and covers an approximately 2 foot by 8 foot section of the frame. Alternately, a platform fabricated of sheets of aluminum, fiberglass or the like between which are sandwiched a fill material, such as plastic foam, can be utilized.

In the prototype, the float 70 comprises a hollow cylinder, measuring approximately 8 inches in diameter and 20 inches long, which can be inflated for extra rigidity. A suitable float is Model No. 218HTM2W, manufactured by Taylor Made. Other floats which can be used in the ramp assembly 10 include those which have larger hollow cylinders, as well as floats filled with a plastic foam material.

It is understood that those skilled in the art may conceive other applications, modifications and/or changes in the invention described above. Any such applications, modifications or changes which fall within the purview of the description are intended to be illustrative and not intended to be limitative. The scope of the invention is limited only by the scope of the claims appended hereto.

1. A ramp assembly adapted for use with a pontoon boat, which comprises:
(a) a support structure having at least one elongated bearing surface track, the support structure being affixed to the under side of the boat in such a way that, in use, the bearing surface track extends generally horizontally;
(b) an elongated platform;
(c) a shaft to which one end of the platform is pivotally connected;
(d) means, including the shaft and at least one bearing block connected thereto which slides within the bearing surface tract, for slideably adjusting horizontal extension of the platform relative to the elongated bearing surface tract;
(e) a floatable body mounted on the platform distal from said end, the floatable body having sufficient buoyancy to float itself and the platform when the platform is extended; and
(f) a means of extending and retracting the platform using the motion of the boat as it moves through the water, the platform being extended when the boat moves in the direction away from the free end, and the platform being retracted when the boat moves in the direction toward the free end.

2. The ramp assembly according to claim 1, wherein the means for extending and retracting the platform comprises a rudder rotatably attached to the platform, portions of the rudder distal from the platform penetrating the surface of the water during use, and which further comprises means for rotating the rudder through an angle of 90 degrees in such a way that the rudder can be disposed perpendicularly to the longitudinal centerline of the ramp so that as the boat moves through the water with the rudder so disposed the force of the water on the rudder causes the platform to move relative to the support structure.

3. The ramp assembly according to claim 2 which further comprises a means for automatically holding the rudder in 90 degree relative to the longitudinal center line of the ramp while the ramp is being extended comprising an extendible pin and a receiving groove in the shaft of the rudder.

4. The ramp assembly according to claim 3, which further comprises a control arm having a key that will fit into the receiving groove of the rudder shaft while the ramp is fully retracted and then movement of the arm can rotate the rudder from parallel to 90 degrees relative to the centerline of the ramp allowing the ramp to move from the stored position to be extended position and the same key will enter the groove disengaging the pin when the ramp is nearly fully retracted and allow control arm to be used to turn the rudder from 90 degrees to 0 degrees for storage.

5. The control arm of claim 4 can be turned in a remote location by pulling on it with a rope.

6. A means of extending and retracing a ramp platform assembly adapted for use with a pontoon boat, which comprises a rudder rotatably attached to the platform and having its distal end penetrating the surface of the water, and a means for rotating the rudder from zero to ninety degrees from the longitudinal center line to the ramp so that a force will be supplied to the ramp from the rudder as the boat moves in the water.

7. A means of extending and retracting a ramp platform for use with a pontoon boat, according to claim 6, wherein the means for rotating the rudder further comprises a locking mechanism having a key attached to the boat that allows simultaneously rotation of the rudder from zero to ninety degrees from the longitudinal center line of the ramp and release of the ramp for extension and when the ramp is retracted allows simultaneously rotation of the rudder back to the zero degrees and locking of the ramp in stored position on the boat.
